(19) United States
(12) Patent Application Publication
(10) Pub. No.: US 2013/0198012 A1
(43) Pub. Date: Aug. 1, 2013

(54) Process for creating, for use over the Internet or other public communications network, an electronic sales advertisement with a voiceover incorporating a choice of various styles and languages

(71) Applicants: Michael Stimmel, Scottsdale, AZ (US); Vince Hansen, Roslyn, WA (US); Fei Chen, Redmond, WA (US)

(72) Inventors: Michael Stimmel, Scottsdale, AZ (US); Vince Hansen, Roslyn, WA (US); Fei Chen, Redmond, WA (US)

(21) Appl. No.: 13/364,296

(22) Filed: Feb. 1, 2012

(51) Int. Cl. G06Q 30/02

(52) U.S. Cl. 705/14.72

(57) ABSTRACT

This invention is a process for creating, online, a narrated motion advertisement in different styles and languages, for viewing on the Internet or other public communications networks. It describes the front-end web server, middle tier server, and back-end SQL and file server processes for collecting, storing, and uploading media and other information necessary to create a narrated motion advertisement. Advertisements can be created from various media types, in any major language, and can include various vocal qualities, such as radio-quality voice and singing voice. After completion, the process remains open to further iterations, in order to facilitate advertisement editing and modification. This enables voiceover artists and scriptwriters to gain access, over the Internet, to an unfinished advertisement and create the script and narration for it according to the gender, language, style, and other qualities chosen by that advertisement's owner.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A SEQUENCE LISTING, A TABLE, OR A COMPUTER PROGRAM, LISTING COMPACT DISC APPENDIX

Not applicable

### BACKGROUND OF THIS INVENTION

One of the most rapidly growing segments of the Internet today is online advertising. Online advertising is used to introduce new products, sell a product, promote a business, make a friend, and many other things. The reach of this market touches every newspaper, magazine, forum, bulletin board, and blog whose format includes online advertising, for a fee or not.

In the current marketplace, there is a wide gap between traditional online graphical ads, which are typically not expensive, and online video ads, which can be very expensive. This invention aims to fill that gap by allowing people to create, over the internet, an online advertisement that is as effective as a professionally produced video ad, but much easier to produce and costing far less.

Until now, in order to create a quality online advertisement, one had to hire an advertising company to produce the ad. Either that, or purchase special software that could easily run several thousand dollars, for which the learning curve can be very steep, and produce the ad yourself. In that case you would have to know how to write a script and how to record a voice message for your advertisement, and the voice message would have to be of a quality that would reflect well on whatever product, service, or idea you are advertised. Obviously, this would be a daunting task for most, because it is not an easy undertaking to record a smooth, convincing narrative for an online advertisement. This invention allows people and businesses to inexpensively create a quality online motion advertisement, fully narrated, in different styles and languages, for use on the Internet or other public communications networks. Advertisements can be created in multiple languages, with a radio-quality voice-they can even be sung.

### BRIEF SUMMARY OF THE INVENTION

The goal of this invention is to give everyone who can read and write and operate a computer, laptop, cell phone or similar device, the ability to create and share an inexpensive, effective, professionally narrated full-motion online advertisement for their idea, product, or service.

This invention can satisfy a wide range of advertising needs, from simple to complex, from dry to creative, in any major language, giving it true global appeal. It enables any user with Internet access to create a professionally narrated advertisement for any idea, product or service without specialized software. The advertisement is created online and stored entirely in the “cloud” for whatever period of time that has been agreed-upon between the licensor and the user.

Unlike most Internet transactions that are closed once they are completed and therefore impossible to modify, this invention is not a closed process. An advertisement can be modified after it has been created and posted on the Internet, to correct errors, add information, or update pricing. This is a very powerful and unique feature. Not only does it eliminate the time and cost of having to redo an advertisement just to make a simple change, it also reduces potential frustration and makes the overall experience a more enjoyable one.

One of the keys to effective communication is obviously the spoken word. Recognizing this, this invention provides not only a vivid visual advertisement, but also a versatile voice message in different styles and in any major language or even multiple languages. Whether you're in New York, Hong Kong, or Paris, a message created with this invention is equally effective.

The ease-of-use characteristics of this invention are further enhanced by its ability to accept input from a Mobile Device. A user can execute a dedicated mobile application, which utilizes the built-in camera and microphone of his or her Mobile Device to provide advertisement content, and then upload that content for processing utilizing the web services provided by this invention's front-end. In this way, users who do not have knowledge of how to use a PC or PC browser will still be able to use this invention.

### BRIEF DESCRIPTION OF THE SEVERAL VIEWS OF THE DRAWINGS

FIG. 1: Overall Architecture, shows the process flow beginning at the front-end client level, then moving to the middle-tier, dealing with the invention processing engine, and finally to the storage-tier, dealing with the storage and retrieval of user information, advertisement information, advertisement media, configuration files and player files.

FIG. 2: Advertisement Information Gathering (front-end), describes how the web front-end servers gather advertisement information via web pages and callable web services.

FIG. 3: Advertisement Processing (middle-tier), describes the advertisement processing engine running in the middle-tier server, which fetches user-published advertisements and processes them one-by-one. Once the process is complete for a given advertisement, that advertisement is ready for viewing.

FIG. 4: Detailed View of Generate Advertisement-Specific Files (middle-tier), shows an expanded view of the “Generate advertisement-specific files” step in FIG. 3, and describes how advertisement-specific files are generated.

FIG. 5: Download and Play Advertisement (storage-tier, browser, mobile application), describes how a web browser or mobile application downloads and plays an advertisement.

FIG. 6: Advertisement Creation Flow, describes the flow an end-user follows in order to create an advertisement.

FIG. 7: Expanded View of Advertisement Information Flow, provides an expanded view of the “Enter detailed information for advertisement” step in FIG. 6.

FIG. 8: Advertisement Editing Flow, describes the flow an end-user follows to edit an existing advertisement owned by that user.

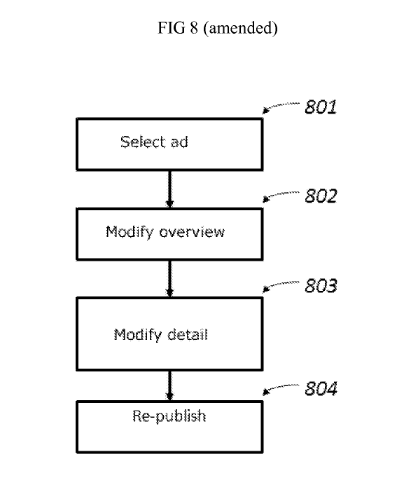

FIG. 9: Instant Voice Recording, is an expanded view of the “Instant Recording” step referred to in FIG. 7. It describes the ability, from inside a browser or mobile application, to instantly record a voice for a given advertisement.

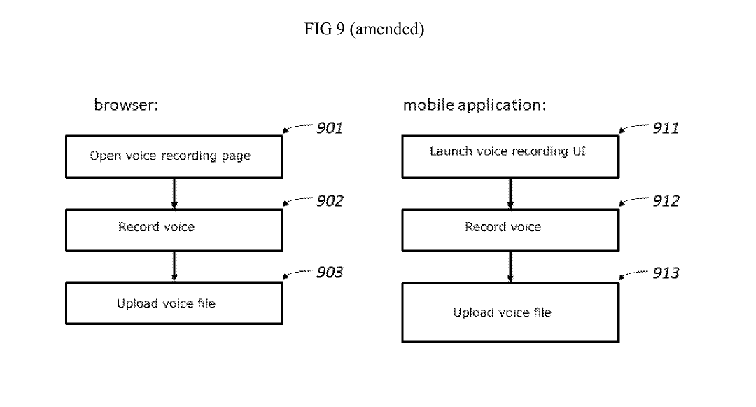

FIG. 10: Request Professional Voiceover, is an expanded view of the “Request professional voiceover” step in FIG. 7. It describes how a user submits a request for a professional voiceover.

FIG. 11: Advertisement Management, describes the advertisement management UI and its corresponding actions.

FIG. 12: Voiceover Request Reservation, describes how a voiceover artist reserves a voiceover request from a queue of open requests submitted by various users. A voiceover request is considered to be “owned” by the voiceover artist once it has been reserved by that artist.

FIG. 13: Voiceover Request Fulfillment, describes how a voiceover request artist fulfills a voiceover request. A request is considered fulfilled when voice audio files have been recorded and uploaded, and the advertisement has been re-generated with those audio files.

FIG. 14: Script Request Reservation, describes how a scriptwriter reserves a script request from a queue of open requests. A script request is considered “owned” by the scriptwriter once that scriptwriter has reserved it.

FIG. 15: Script Request fulfillment, describes how a scriptwriter fulfills a script request. A request is considered fulfilled when script files have been written and uploaded, and the one who has requested the script has been notified.

FIG. 16: Screen Capture 1, (not used)

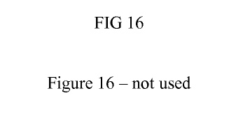

FIG. 17: Screen Capture 2, shows Your Current Advertisements Screen

FIG. 18: Screen Capture 3, shows Advertisement Overview Screen

FIG. 19: Screen Capture 4, shows Add Media Screen

FIG. 20: Screen Capture 5, shows Request Voiceover Screen

FIG. 21: Screen Capture 6, shows Voiceover Reservation Screen

FIG. 22: Screen Capture 7, shows Voiceover Fulfillment Screen

FIG. 23: Screen Capture 8, shows Script Reservation Screen

FIG. 24: Screen Capture 9, shows Script Fulfillment Screen

### DETAILED DESCRIPTION

The process being patented belongs to the applicant named above, and “Qwick Pitch” is one of potentially many marketing names associated with and synonymous to said invention. Accordingly, the expressions “this invention” and “Qwick Pitch” will be used interchangeably.

The Qwick Pitch “engine” refers to the steps online and the background processing necessary to generate a finished advertisement.

“Qwick Pitch website” refers to any website licensed to use Qwick Pitch technology and containing the step-by-step process for creating an advertisement.

A “user” is defined as any customer licensed to use Qwick Pitch technology and who is the owner of at least one Qwick Pitch advertisement, whether it be completed or in the process of being completed.

A “viewer” is defined as anyone in the public who chooses to view an advertisement created with Qwick Pitch technology.

A “licensor” is applicant Vince Hansen, Fei Chen, and Michael Stimmel, or any company formed by same to market this invention, or any company or affiliate that has been granted the right by applicant to promote and market this invention.

A “licensee” is normally the same as a “user,” a person who has been granted a license to use Qwick Pitch technology.

A “partner” is any company or individual with a written agreement from licensor to promote Qwick Pitch technology in one form or another to the general public.

The “cloud” is a general reference to a network of servers residing in a data centers either on-premise or maintained by cloud-service companies like Amazon EC2/S3 or Microsoft Azure, that are capable of providing data security, scalability, and data redundancy for global deployment of services such as Qwick Pitch.

“Advertisement” or “ad” refers to a moving voice-and-image message that can be viewed on the Internet or mobile devices with the use of any popular media player such as Flash, Silverlight, or as an embedded player on a web page designed to deliver content to viewers.

“Screens” refer to web screens or user-interface screens on mobile devices, created to manage the user flow of creating an advertisement.

“He” for sake of brevity will be construed to mean “he or she.”

The steps to creating an advertisement are essentially the same for any product, service or idea. Depending on the particular market application that Qwick Pitch technology is trying to satisfy, some Qwick Pitch features may be turned off in order to make the creation of an advertisement simpler, more streamlined, and less expensive.

Qwick Pitch architecture has three basic levels: front-end, middle tier, and storage tier. Each level satisfies crucial parts of the overall process.

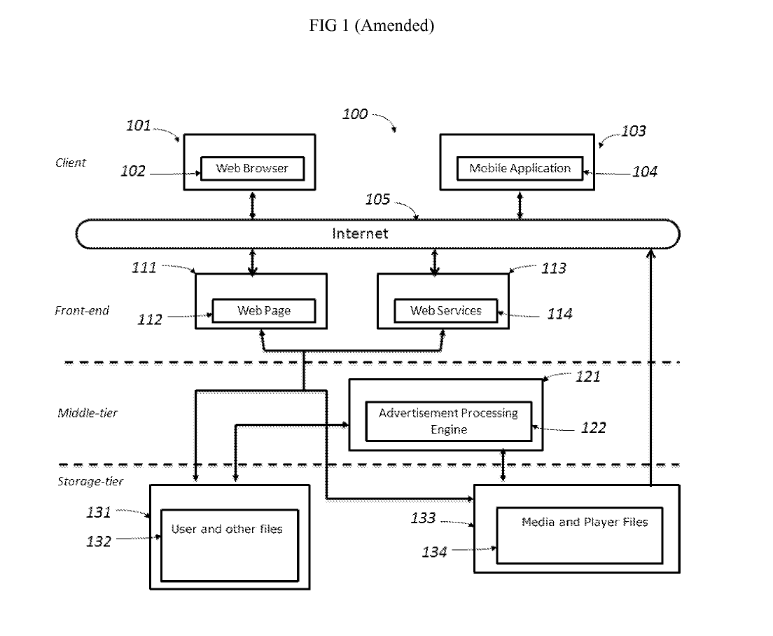

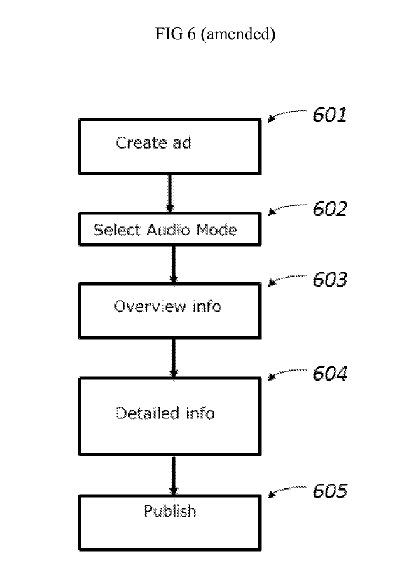

For sake of easier understanding, the description will begin with user interaction flow charts, FIGS. 6 and on, which together describe the various features of this new process and how a user interacts with these features to create an advertisement. Then the focus will turn to the system architecture of the invented process and the hardware and software implementations that allow the process to occur from a computing standpoint, as illustrated by FIGS. 1 through 5.

Part 1. End User Flow:

End users interact with the Qwick Pitch invention via web sites or mobile applications. By using a client device such as a PC, phone or other device with Internet connectivity, a user is able to access a Qwick Pitch web site, which steps a user through a number of web pages for creating a Qwick Pitch advertisement. Mobile users can also download and run the applications written for Qwick Pitch to exercise the same functionalities that are provided from the web page.

Once a potential user decides to become a customer, he logs in by providing a valid email and password, and then proceeds to Screen 1, Personal Information, and provides full name, address, company name if applicable, phone number, email, and a picture of person or company if desired.

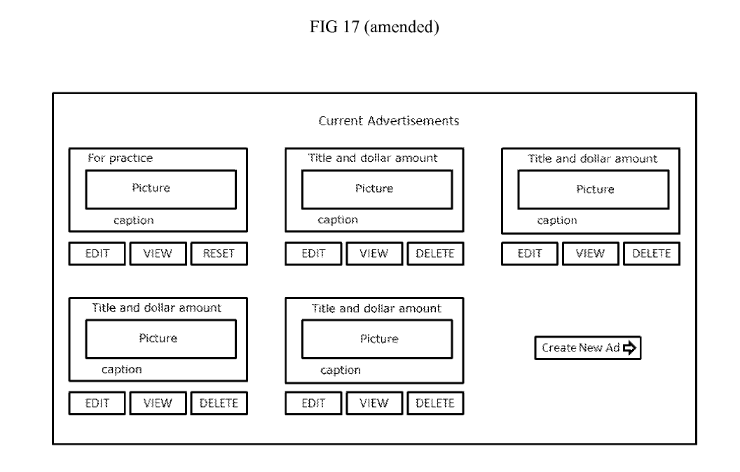

When finished, Screen 2, Your Current Advertisements appears (as illustrated by FIG. 17 in the list of drawings). This screen allows a user to view and manage his advertisements, and create new ones. It also gives a new user the choice of creating a free practice advertisement. Clicking on “Free Practice Advertisement” takes the user to the same series of Add Media screens as a non-practice advertisement would, but with ad media, music, and voice files all ready to use.

When a user is ready to start a new advertisement, he clicks the Create New Ad button on the UI screen to start the Advertisement Creation Flow (as illustrated by FIG. 6) and is presented with a list of choices representing advertisements of different lengths and style requirements. This is where a user must decide how long an advertisement will be, and whether there are any special requirements, such as a radio-quality voiceover or background music. The following is just one example of those choices:

1-minute Advertisement with Standard Voiceover

1-minute Advertisement with Radio-quality Voiceover

1-minute Advertisement with Singing Voiceover

2-minute Advertisement with Standard Voiceover

2-minute Advertisement with Radio-quality Voiceover

2-minute Advertisement with Singing Voiceover

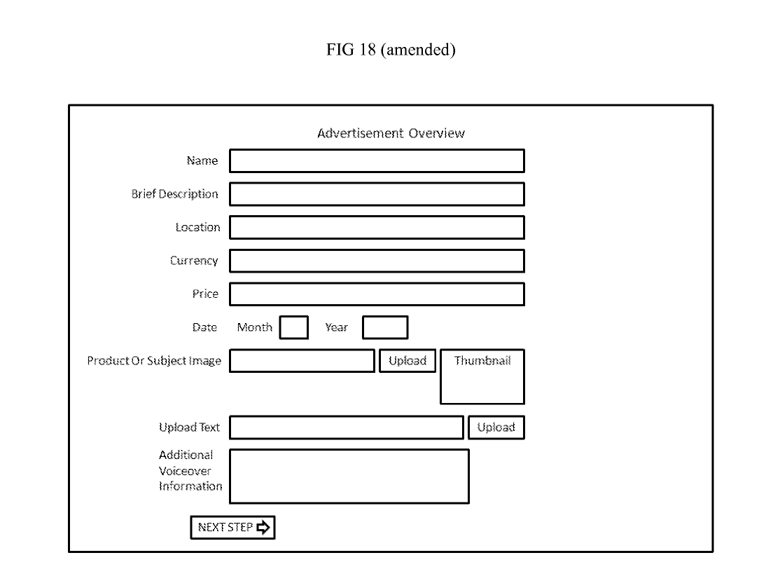

The user is then taken to Screen 3, Advertisement Overview (as illustrated by FIGS. 6 and 18). This is the input screen for the advertisement's title, brief description, location (ie, Seattle), currency, overview image of product or service, price of product or service, and other account-keeping details, as required.

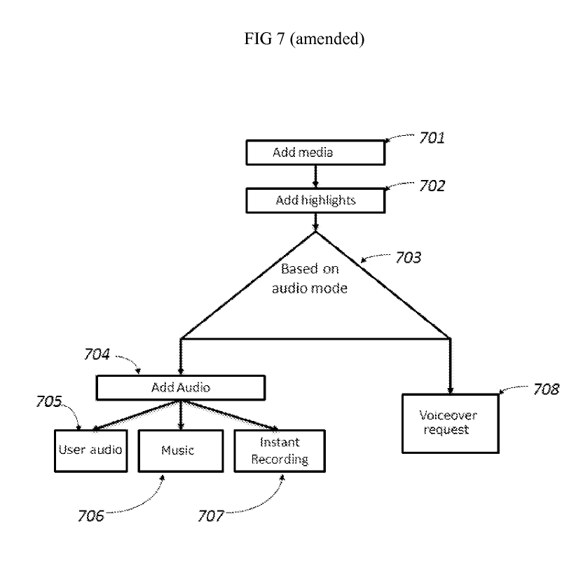

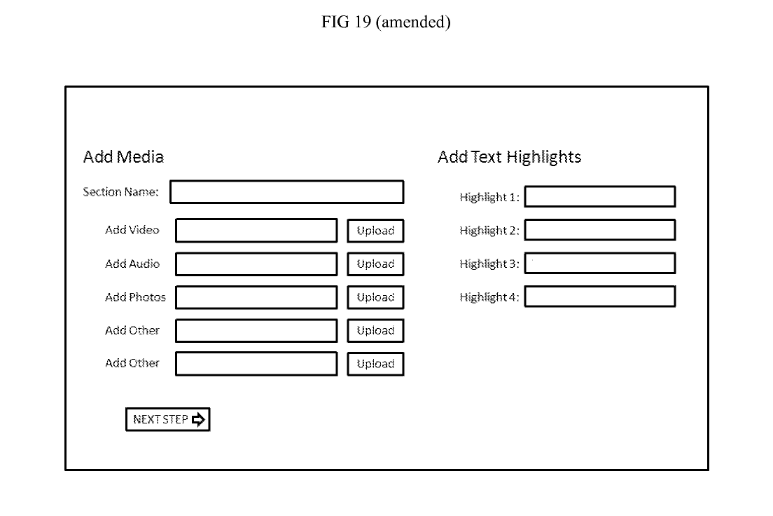

Once Advertisement Overview information has been completed, a new screen appears, Add Media (as illustrated by FIGS. 7 and 19). This screen, or screens depending on the complexity of the ad, allows the user to browse his computer or other Internet device for content to add to his advertisement. Content can include things like drawings, photos, screen captures, video, music, and sound files.

In addition, a number of empty text blocks labeled “Highlights” are available so that the user can add text information to supplement and/or highlight the media he has selected to upload.

Although the primary message and therefore the effectiveness of a Qwick Pitch advertisement lies chiefly in its voice message, some users may feel they don't need a voice message. These users have the choice of listening to and selecting a track of Qwick Pitch Royalty-Free Music to be used in the advertisement.

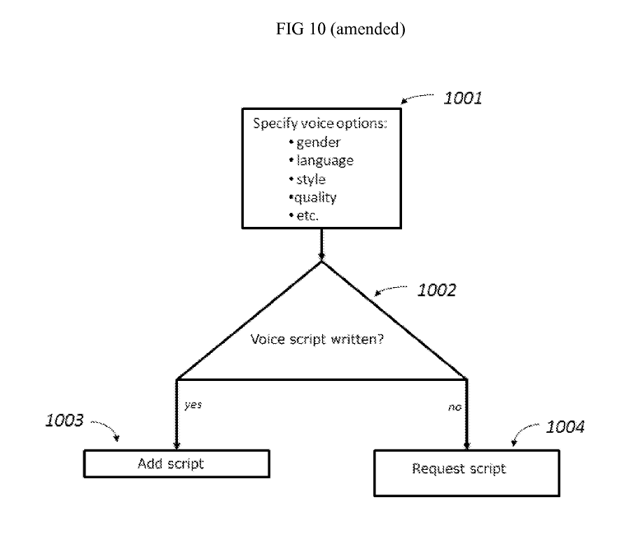

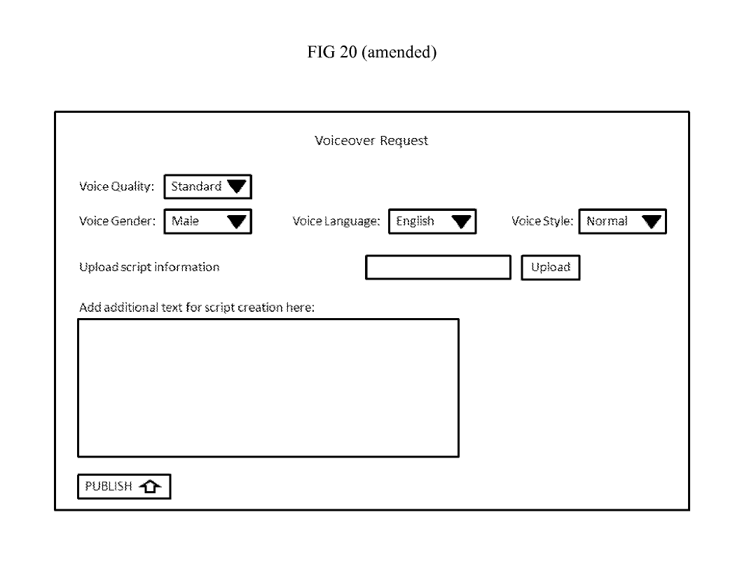

After adding media for upload, the user is then brought to the Request Professional Voiceover screen (as illustrated by FIGS. 10 and 20). This is a rich feature that satisfies multiple potential user needs: 1) the user may have previously created an advertisement in the user's native language, and now wants a similar advertisement in a different language, or 2), the user may be a small business needing an advertisement for its web site with voice narration of a professional quality, or 3) the user may need an ad that is of the highest professional quality, comparable to a radio ad, or 4) the user may want an ad sung or even performed with music.

On the Request Professional Voiceover screen, a user may select from a number of options for a professional voiceover by a voiceover artist, including but not limited to: gender, language, style of delivery, and quality. Quality choices include standard, radio-quality, and singing voice. Once those have been decided, a user may provide text information for the basis of a voiceover script in two ways: by typing the information into a text box available for that purpose, and/or by uploading a text or .pdf file with that information.

A user's Request Professional Voiceover information is saved to a server in the storage tier, and the information is made accessible to voice artists the world over, so voiceover requests may be fulfilled by different people, at different locations, at different times. This crowd-sourcing, collaborative framework is integral to the quality and behavior of Qwick Pitch and a clear example of the globalization of its process.

Now that all ad media has been uploaded and a voiceover selection made, the Publish button (Box 605 in FIG. 6) triggers the ad generation process. A rough-draft advertisement is generated with music temporarily substituting for voice, so that a user can view his ad with the media he selected. Also, a user's Your Current Advertisement screen is updated with the new advertisement depicted by a large thumbnail and a brief text description.

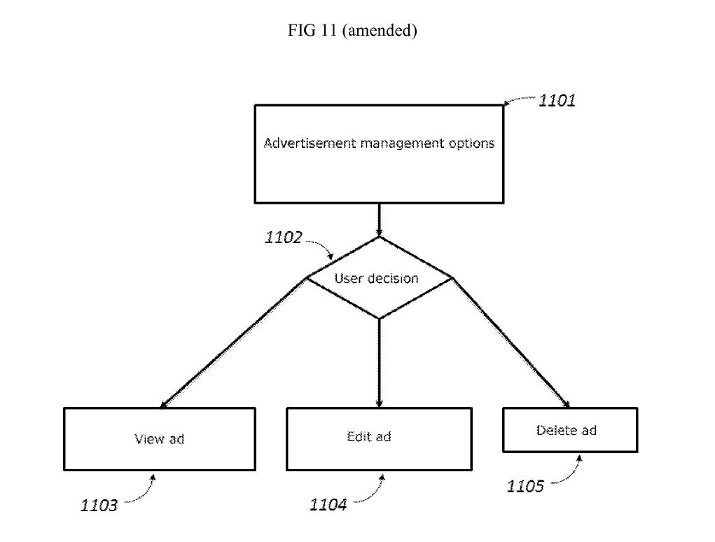

The Your Current Advertisement screen also provides Advertisement Management functionalities, including but not limited to View, Edit, and Delete (As illustrated in FIG. 11), through front-end web services. Mobile applications running on mobile devices, such as iPhone, Windows Phone, Android Phone, etc., can call directly into these web services to create and edit advertisements. Users of these mobile applications can take video, photos, and record audio, and upload them in the Add Media step described above, combining ease of use and productivity into a pleasant user experience.

To Delete an advertisement on the Your Current Advertisement screen, merely click Delete. To View a completed advertisement (as illustrated in FIG. 11), merely click on the View button below that advertisement's thumbnail photo and the advertisement will play in a Qwick Pitch Flash player overlay window.

To Edit a completed advertisement, click on Edit directly below a advertisement's thumbnail photo and the advertisement creation process is basically repeated, beginning with the Advertisement Overview screen, only this time the data and media previously saved for that advertisement is shown. (See FIG. 7 for an expanded view of Enter Advertisement Information). Editing allows a user to make changes in the description of his advertisement, pricing, and to add or delete media and text descriptions. When finished with editing, the Publish Ad button is clicked again and a new, revised advertisement is saved that overwrites the old one.

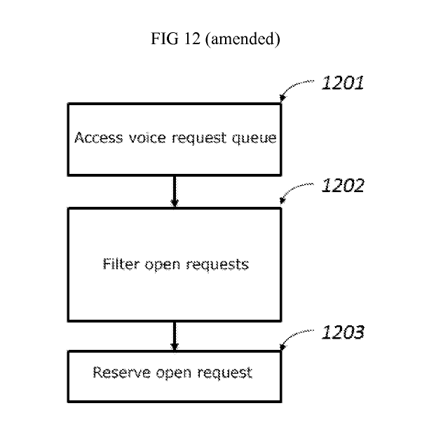

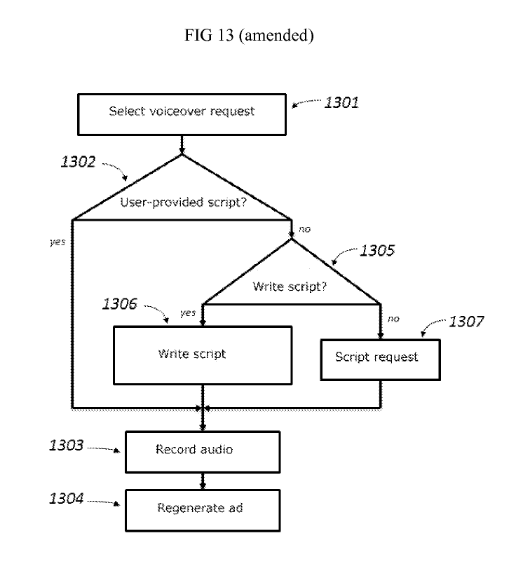

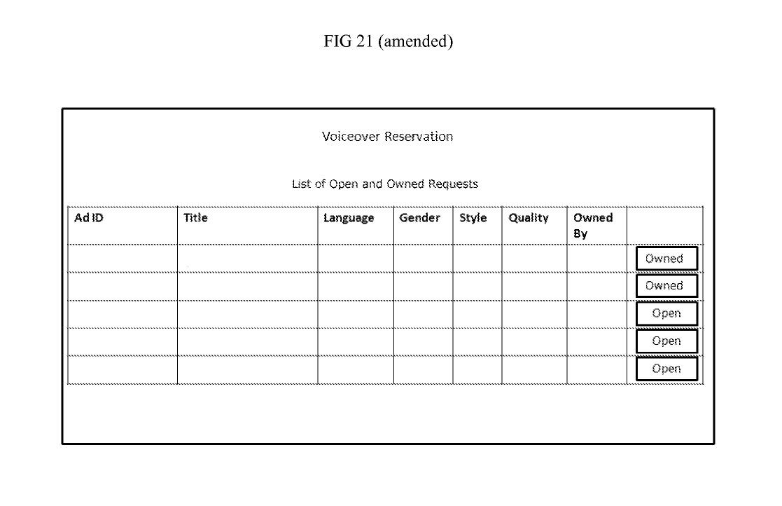

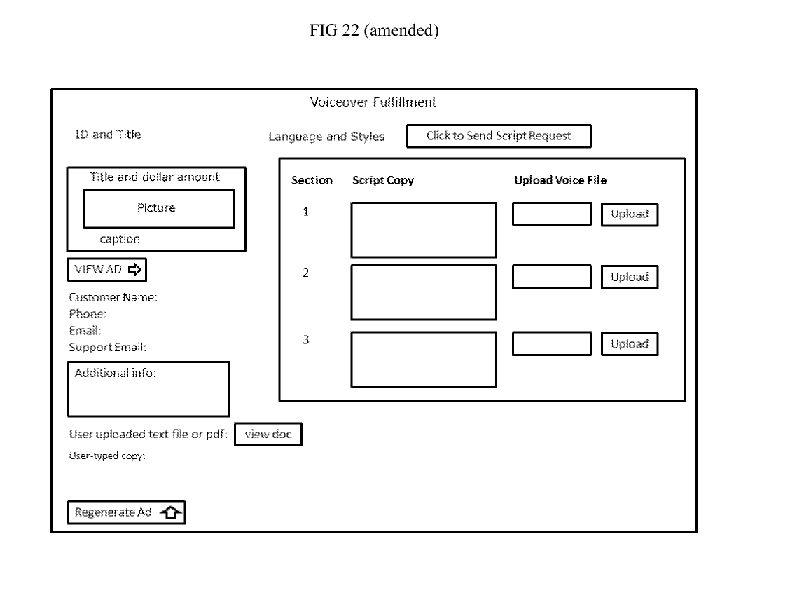

Once a user's advertisement information has been saved on a Storage Tier Server, it is now accessible to voiceover artists the world over who have Qwick Pitch log-on rights to a private Voiceover Reservation web page (As illustrated by FIGS. 12 and 21). A list of all open and “owned” Voice Requests resides here, indicating an advertisement's language, gender, style, and chosen quality, as well as its ID, title, and other tracking details. A voice artist uses this process to reserve a voice request by clicking on it, at which point its status changes from Open to Owned. Once a request is owned, it is indicated by “Owned” on the Voiceover Reservation screen and the voice artist is taken to the Voiceover Fulfillment screen (As illustrated by FIGS. 13 and 22).

The Voiceover Fulfillment screen has all the information that a voiceover professional needs to do a voiceover: a picture of the product or service, the text file or .pdf that has been uploaded by the user to provide scripting information, and any information a user may have typed in for this purpose. In addition, the voice artist has the ability to click a “View Ad” button and watch a moving, rough-draft version of the advertisement with timeline for reference. As well, there is an email address and other information associated with the user that originated the request.

As described in Part 1 above, a user may provide text information for a voiceover script by typing the information into a text box available for that purpose, or by uploading a text or .pdf file with that information, or both. A voice artist's first step is to decide whether he will create a script for the voiceover (Box 1306 in FIG. 13), or make a Script Creation Request (Box 1307 in FIG. 13).

The script creation process has been broken down into sections, normally 15-seconds long but others lengths may be more appropriate, depending on the advertisement. So a 1-minute ad based on 15-second sections would have four sections total. Each section accommodates up to 4 lines of text. If the voice artist decides to write the script himself, he builds it in 15-second sections using the template on-screen provided for this purpose. The voiceover artist must take the information provided by the user and create an appropriate script, which is sent back to the user for approval. When satisfied, the voice artist finalizes the script, then records his voice. This may be done offline if the voice artist prefers, allowing the use of sophisticated recording equipment, or the voice artist may utilize the sound recording applet available within Qwick Pitch, with the ability to Record, Pause, Stop, Replay, and Save a recording. Other features, such as sound editing, may be added over time. When the voice artist has completed the voice recording, he uploads it and Regenerates the advertisement by clicking on the button at the bottom of the screen labeled “Regenerate Ad”.

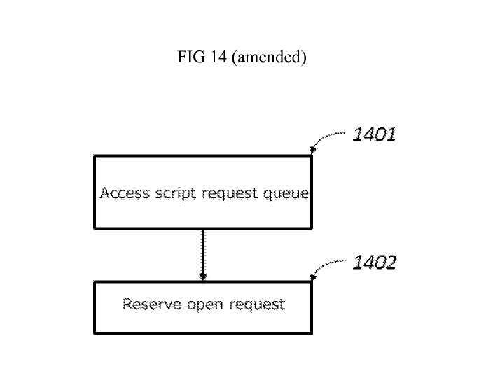

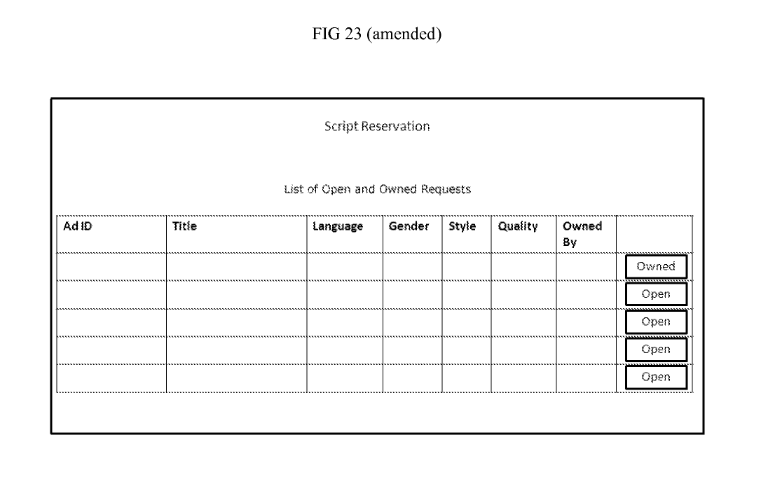

If a voice artist chooses not to write a script for a particular advertisement, he makes a Script Creation Request from his Voice Fulfillment screen by clicking the “Click to Send Script Request” button, which adds the advertisement to a Script Queue on the Script Reservation screen (as illustrated by FIG. 14 and FIG. 23). This screen is much like the Voice Reservation screen, only for scriptwriting, and describes the advertisement language, gender style, quality as well as listing the advertisement ID, title, and other tracking details. A scriptwriter uses this screen to reserve a script request by clicking on an Open script request, which changes it to Owned. A scriptwriter is then brought to a Script Fulfillment screen specifically for that advertisement. This screen is similar to the Voice Fulfillment screen described above, but it does not allow voice to be recorded or uploaded, nor does it allow an advertisement to be regenerated.

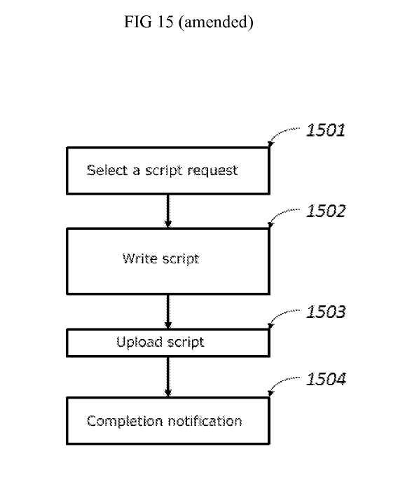

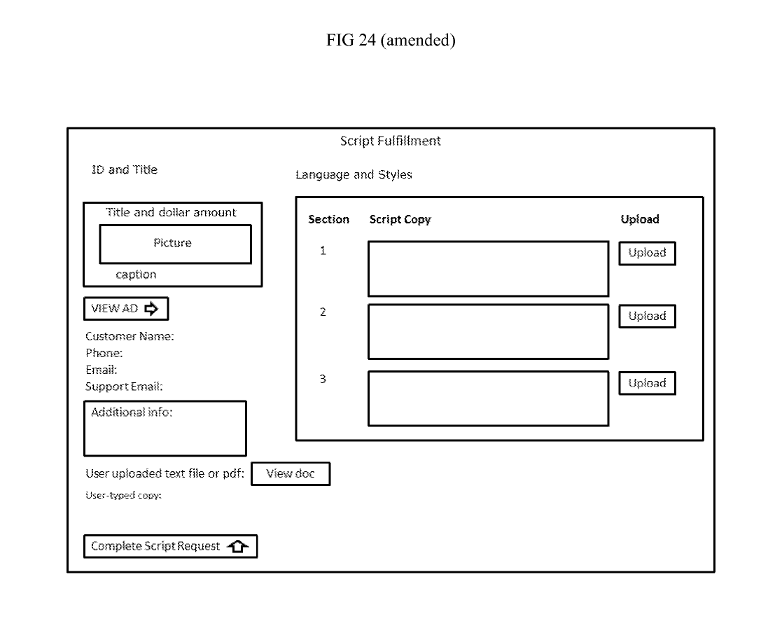

On the Script Fulfillment screen, the script creation process (as illustrated by FIG. 15 and FIG. 24) is basically the same as that described above for the voice artist. It has been broken down into sections, each section normally enough for up to 3-4 lines of text, representing about 15 seconds of recorded voice. The scriptwriter must take the information provided by the user and create an appropriate script, which is sent back to the user for approval. When satisfied, the scriptwriter finalizes the script and clicks “Upload.” At that point the script information is automatically saved to the Voiceover Fulfillment screen for that particular advertisement. Now the voice artist can record his voice, as previously described in the steps above for that purpose.

Once a voiceover is completed, the advertisement is regenerated, a notification is sent to the user who owns it, and the user's Your Current Advertisements screen reflects a voice-narrated advertisement in the gender, style, and language requested by the user.

To make a finished advertisement available on another website or in an email or another form of electronic communication, a user need only fetch the URL link that Qwick Pitch has sent to the user's email address on file. This URL link may be a simple URL address, or a thumbnail picture of the advertisement with embedded URL link, or even a web page with thumbnail and embedded link.

The URL link of a newly edited advertisement is the same as it was for the original advertisement, therefore there is no need for the user to replace the URL link to his advertisement that he may have previously posted on a website, in an email, or another form of electronic communication. This allows the edit process to be repeated with no disruption of the URL links already in place to share a given advertisement.

System Flow Charts:

FIGS. 1 through 5 describes the system architecture of the invented process and the hardware and software implementations that allow the Qwick Pitch process to occur from a computing standpoint. The proposed architecture and implementation is just one of the many possible embodiments of the process.

FIG. 1 describes the overall architecture of the software and hardware system that implements the Qwick Pitch process. The system consists of four categories of components: Client, Front-End Servers, Middle-Tier Servers, and Storage-Tier servers.

Client is represented by client computers (box 101) or mobile devices (box 103) which have the access to the public communications network such as the Internet (box 105).

Client computers interact with Qwick Pitch servers through web browsers (box 102). Advertisements are generally created, edited, and managed by accessing web pages on the web servers. Advertisements are played by the Qwick Pitch player, which runs on a browser plug-in such as Adobe Flash or Microsoft Silverlight.

Mobile devices interact with Qwick Pitch servers through Qwick Pitch mobile applications (box 104). Modern smart phones have strong computational and networking power to download and render multi-media contents such as images and audios. Developer tools are constantly improving, making mobile application development easier and easier.

The Front End is represented by web servers (box 111 and box 113). This is where the Qwick Pitch web sites are hosted. By using a client device such as a PC, phone or other device with Internet connectivity, a user is able to access a Qwick Pitch web site (box 112), which steps the user through a number of web pages for creating a Qwick Pitch advertisement.

The same functionalities are also provided through front-end web services (box 114). Mobile applications running on mobile devices, such as iPhone, Windows Phone, Android Phone, etc., can call directly into these web services to create and edit advertisements. Users of these mobile applications can take photos, record audio and video, and create advertisements all in one place, combining ease of use and productivity into a pleasant user experience.

Voiceover artists and scriptwriters also access the Qwick Pitch process through this front-end to perform the request-reservation and request-fulfillment tasks.

The Middle Tier of the Qwick Pitch process is represented by general purpose processing servers (box 121), located on-premise or in the cloud. The Advertisement Processing Engine (box 122) running on these servers generate an advertisement based on the information gathered from the front-end servers. Middle tier servers also interact with the Storage Tier servers to store and retrieve meta-data and media files from them.

Middle Tier servers are an important building block in our proposed architecture, making high scalability possible. They decouple the information gathering UI tasks performed by the front-end servers from the actual advertisement-generation tasks performed by the middle-tier servers. This enables so called asynchronous fire-and-forget operations. In other words, users will be prompted back to the UI right after all the information is uploaded and do not have to wait for the time consuming advertisement-generating process to be completed. Everything else happens in the background, so users will enjoy a snappy UI.

Another benefit of the middle tier architecture is that the front-end and middle tier can now be independently scaled, depending on the actual work load. For example, if the front-end work load is too heavy, the number of front-end servers (or virtual server instances in the case of cloud hosting) can be increased to ease the pressure on the front-end, without changing the number of middle-tier servers. Vice versa, if the bottleneck is in the middle-tier, only the number of servers (or virtual server instances) in the middle-tier need be increased.

This ease of scalability translates into money savings, which can in turn be passed on to the user, and shorter wait times to upload files and to generate finished advertisements, enhancing a user's overall Qwick Pitch experience.

The Storage Tier of the Qwick Pitch architecture consists of database servers (box 131) and file servers (box 133).

The database server is where the advertisement meta-data such as user information, advertisement information, voiceover requests, and script requests are store and indexed (box 132). The file Server is where pages images, audio, web page files, browser plug-in player files (such as flash .swf files or Silverlight .xap files), advertisement configuration files, and other files are stored (box 134).

The result of de-coupling the raw media files from the advertisement meta-data is a highly scalable system which takes advantage of both the quick indexing capability of the databases and the massive storage capability of the file servers.

Another benefit of this design, in addition to scalability, is added flexibility, as any logic change related to how an advertisement is generated can now be centralized into the database access code without changing any code that deals with the file servers.

Many mature database server products are available today. In the case of on-premise servers, this could be MS SQL or Oracle database servers sitting behind the firewall in the DMZ. In the case of cloud implementation, the database could be a cloud DB solution such as Microsoft SQL Azure, Amazon Relational Database Service, or Amazon SimpleDB.

Many mature file storage server products are available today also. In the case of on-premise servers, this could be Windows or Unix based file servers sitting behind the firewall in the DMZ. In the case of cloud implementation, it could be Amazon S3 or Azure Storage Services.

With the overall architecture of FIG. 1 in mind, the detailed descriptions of tasks performed by the servers in the Qwick Pitch process are described below.

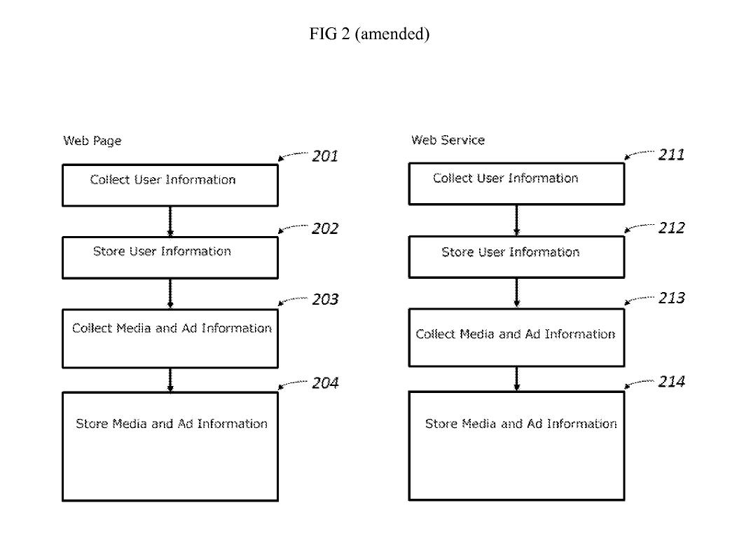

FIG. 2 describes the detailed process how the web front-end servers gather advertisement information by providing web pages and callable web services.

Web pages or web services are provided to collect user information, advertisement meta-data and advertisement raw media files. The user information and advertisement meta-data are then stored on the database server, while the advertisement raw media files are stored on the file servers.

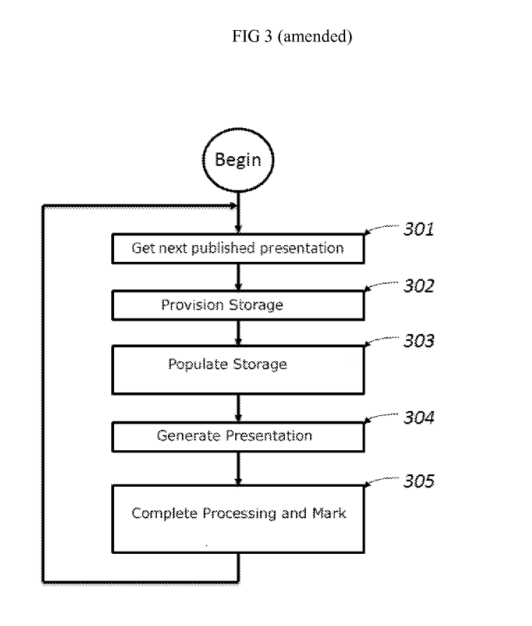

FIG. 3 describes the detailed process how the Advertisement Processing Engine processes the published advertisements.

The Advertisement Processing Engine runs in an infinite loop, querying the database for the next published advertisement to process (box 301).

Once a published advertisement is found, the engine goes through the following four steps (box 302 to 305) to generate a viewable advertisement:

Step 1: (box 302) The storage for storing the final advertisement files will be provisioned. Each advertisement is given its own unique storage space, which could be a sub folder on a web server, a storage space in the cloud storage, etc.

Step 2: (box 303) Certain files necessary for building an advertisement are not advertisement-specific. Examples are the advertisement template html file, Flash player .swf file, Silverlight player .xap file, Royalty-Free music files, etc. These files are copied to the advertisement storage space provisioned in Step 1. Alternatively, these non-advertisement-specific files could be stored in a shared location for all advertisements.

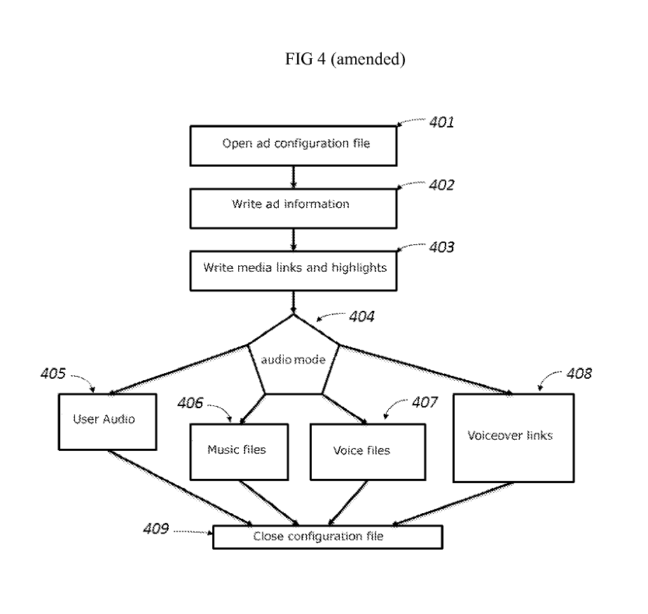

Step 3: (box 304) Advertisement-specific files such as the advertisement configuration XML files are generated by Qwick Pitch's proprietary code and placed in the advertisement storage space provisioned in Stepl. For an expanded view of this sub-process, (see FIG. 4: Generate Advertisement-Specific Files (middle-tier)).

Step 4: (box 305) At this point, the processing of this advertisement is completed. The advertisement is marked as ready for viewing. The Advertisement Processing Engine loops back to box 301 to find the next published advertisement.

FIG. 4 is the expanded view of box 304 which describes the detailed process how advertisement-specific files are generated. In Qwick Pitch, advertisement-specific information is stored in an XML file called “Advertisement Configuration File”. This XML file is produced by the Advertisement Processing Engine via applying the predefined code logic to the user information and advertisement meta-data stored in the database. The resulting XML file contains all the needed information for the player to play the advertisement.

Below is the detailed description of how the advertisement configuration file is generated:

Step 1: (box 401) A blank file is created for writing.

Step 2: (box 402) Basic advertisement information including pricing, location, description, etc. is written to the file.

Step 3: (box 403) The URLs of the advertisement media and thumbnail images are added to the file. The highlight texts are also added to the file.

Step 4: (box 404) Based on the “audio mode” of the advertisement, one of the following four audio links will be added to the file:
Audio links to user-uploaded audio files (box 405)
Audio links to the royalty free music files (box 406)
Audio links to the instantly recorded voice files (box 407)
Audio links to the professionally recorded voice files (box 408)

Step 5: (box 409) At this point, the configuration file is successfully created and closed.

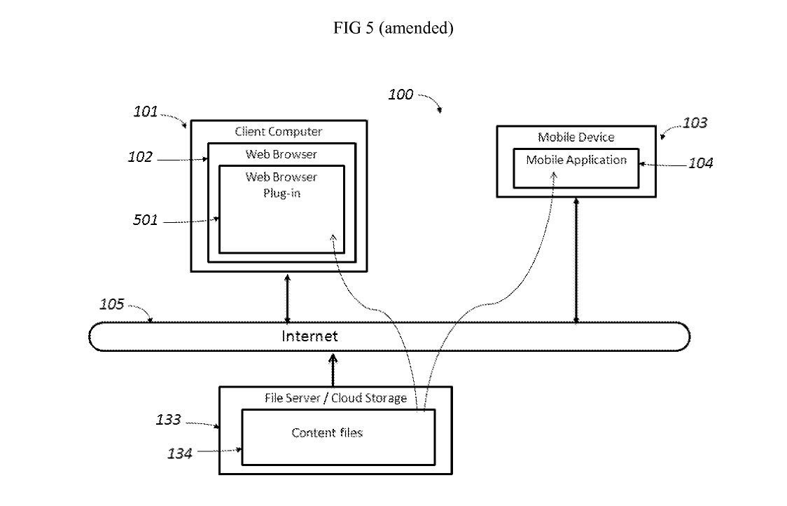

FIG. 5 highlights the sub-view of the overall system (as shown in FIG. 1) to show only the components involved in the advertisement viewing. Advertisements can be viewed inside the web browser plug-ins. When users put the advertisement URL in the browser address bar, the browser will download the HTML files, player files, and advertisement configuration XML file to the client computer. Once the player starts playing inside the plug-in (box 501), it will further download media files from the Qwick Pitch storage tier.

Advertisement can also be viewed by Qwick Pitch applications (box 104) running on the mobile devices. In this case, the mobile application downloads all the files needed, and plays the advertisement using the powerful multimedia capabilities on the device.

It should be noted that the entire advertisement playing process is separated from the advertisement creation process. In other words, the web front-end for gathering advertisement information and the storage-tier databases are not needed when playing the advertisement. Such architecture allows for the maximum scalability where the completed advertisements can live in a cloud massive storage (which general is very inexpensive) for very long time. The read-only network traffic for viewing the advertisements is completely diverted from the read-write network traffic for creating the advertisements. This works to provide a more pleasant user experience.

The embodiments of the invention in which an exclusive property or privilege is claimed are defined as follows:

1. A process consisting of front-end web server, middle tier server, and back-end SQL and file server and/or cloud servers, and all the necessary software programming to create, over the Internet or other public communications networks, a narrated motion advertisement for viewing on computers, mobile devices, or comparable mediums.

2. A process as described in claim 1 further comprising a number of steps for collecting, storing, and uploading media and other necessary information for creating a narrated motion advertisement.

3. A process as described in claim 1 further comprising advertisement management functionalities whereby computers, mobile devices and other devices with Internet connectivity call directly into appropriate front-end web services to create, edit, and view online advertisements.

4. A process as described in claim 1 wherein an advertisement is generated, based on specific parameters, from information gathered from corresponding web servers and from meta-data and media files stored on storage tier servers.

5. A process as described in claim 1, further comprising that after completion, the process remains open to further iterations, in order to facilitate advertisement post-creation editing and modification.

6. A process as described in claim 1, further comprising post-creation editing, including regeneration, of a given advertisement.

7. A process as described in claim 6, further comprising post-creation editing and modifications to an advertisement made by someone other than the owner/creator of that advertisement.

8. A process as described in claim 7, wherein a voiceover artist can remotely, via an Internet-connected computer or mobile device, gain access to an advertisement and create the narration for it according to the gender, language, style, and other qualities chosen by the owner of that advertisement.

9. A process as described in claim 8, further comprising the steps that a voiceover artist takes to create a script for a given advertisement according to the gender, language, style, and other qualities chosen by the owner of that advertisement.

10. A process as described in claim 8, further comprising how a voiceover artist interacts with a queue of voiceover requests.

11. A process as described in claim 8, further comprising the steps a voiceover artist takes to a) view an advertisement-in-process and any descriptive text information provided by that advertisement's owner, b) access a sound-recording tool for the purposes of recording and saving a voice narration, c) communicate back with an advertisement's owner in order to request additional information, and d) make a script request if desired.

12. A process as described in claim 7, wherein a scriptwriter can remotely, via a computer or a mobile device with Internet connectivity, gain access to an advertisement and write a script for it.

13. A process as described in claim 12, further comprising how a scriptwriter interacts with a queue of script requests.

14. A process as described in claim 12, further comprising the steps a scriptwriter takes to a) view an advertisement-in-process and any descriptive text information provided by that advertisement's owner, b) communicate back with an advertisement's owner in order to request additional information and/or approval of the final script to be used for that advertisement's voiceover, and c) save the final script so that it is available online to the voiceover artist for use in recording narration.

15. A storage-tier process relating to claim 1, consisting of SQL and file servers, wherein advertisement information, including images, audio, voiceover requests, scripts requests, web-page files, browser plug-ins, player files, and advertisement configuration files, is stored for use by middle-tier and front-end servers.

16. A storage-tier process as described in claim 15, wherein SQL and file servers are located in part or entirely in the cloud.
